(19) United States
(12) Patent Application Publication
(10) Pub. No.: US 2015/0277530 A1
(43) Pub. Date: Oct. 1, 2015

(54) DYNAMIC POWER SUPPLY UNIT RAIL SWITCHING

(71) Applicant: INTEL CORPORATION, SANTA CLARA, CA (US)

(72) Inventors: VIDOOT PONNALA RATHNAKAR, Hillsboro, OR (US); PAUL M. ZAGACKI, Lake Oswego, OR (US); SOETHIHA SOE, Beaverton, OR (US); OHAD FALIK, Kfar Saba (IL)

(73) Assignee: INTEL CORPORATION, SANTA CLARA, CA (US)

(21) Appl. No.: 14/229,613

(22) Filed: Mar. 28, 2014

(51) Int. Cl. G06F 1/32; H02J 3/00

(52) U.S. Cl. CPC G06F 1/324; H02J 3/005; G06F 1/3293

(57) ABSTRACT

A system for dynamic power supply rail switching (DPRS), including a multi-rail power supply. The multi-rail power supply includes a main rail and a standby rail. The system for DPRS also includes a memory that is to store instructions and that is communicatively coupled to the multi-rail power supply. The system for DP RS also includes a processor communicatively coupled to the memory and the multi-rail power supply. Further, when the processor is to execute instructions, the multi-rail power supply will also supply power to the system, and in response to an entry condition being met, remove power from the main rail and leave the standby rail ON. Also, in response to an exit condition being met, the main rail powers on and starts to again supply power to the system.

### TECHNICAL FIELD

This disclosure relates generally to a power delivery system and method. More specifically, the disclosure relates to improving the energy efficiency of systems with multi-output power supplies.

### BACKGROUND ART

A power supply of a computing device transfers power from a source, like mains power, to a load, such as a personal computer, while converting voltage and current characteristics. A power supply unit (PSU) can have varying power outputs and rails, which can each provide a single voltage from the power supply unit to components of the computing device. Currently, multi-output power supply units are designed to deliver their highest efficiency at near peak loading, typical loading, and light loading conditions. However, these power supply units are inefficient at the lower end of their load curve. As platforms of the future are expected to operate at even lower load conditions, it becomes important to increase the efficiency of the power delivery system to improve energy efficiency of the systems as a whole.

### BRIEF DESCRIPTION OF THE DRAWINGS

The following detailed description may be better understood by referencing the accompanying drawings, which contain specific examples of numerous objects and features of the disclosed subject matter.

FIG. 1 is a block diagram of a system;

FIG. 2 is a process flow diagram for dynamic rail switching; and

FIG. 3 (3A and 3B) is a process flow diagram for dynamic rail switching detailing entry conditions and exit conditions.

FIG. 4 is a block diagram of a PSU embodiment;

FIG. 5 is a timing diagram illustrating a possible timing for the switching of rails.

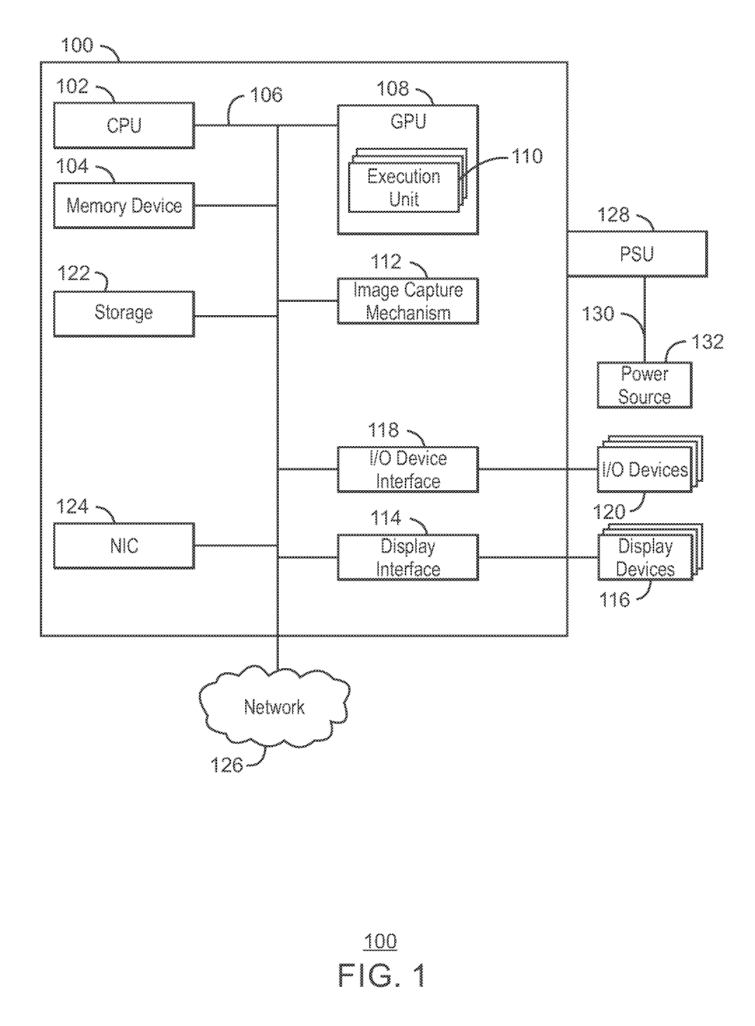

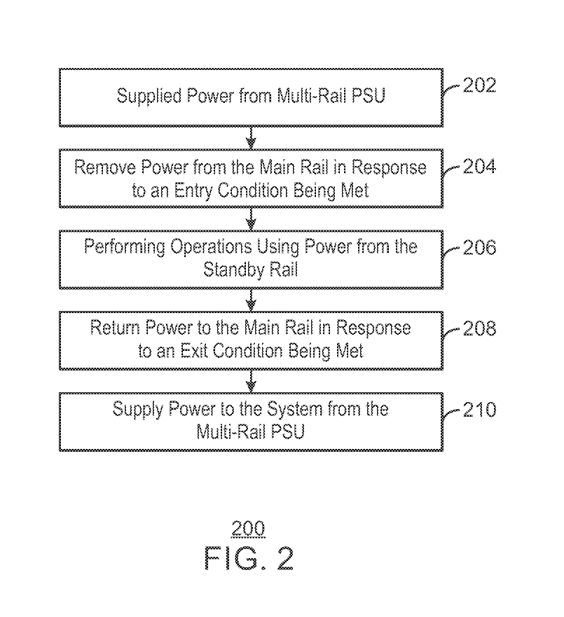

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

A power supply unit (PSU) is the device that powers a computer, servers or data center devices. PSUs may provide power through power supply rails, also known as voltage rails. These rails may often be a group of traces on the PSU's mainboard. The traces on the PSU's mainboard may be copper on a circuit board, or any other pathway that carries electricity on the PSU mainboard. The voltages supplied by a PSU can vary depending on the particular form factor of motherboard the PSU is designed for. Depending on the particular standard being used in a system, there may be a separate rail for individual voltages including+3.3 V, +5 V, +12 V, −5 V, and −12 V. Commonly, a standby rail will have a voltage of +5V. However, other voltages may also be used or become standards for various components and devices.

Various ratings and certifications may be given to a system's power supply unit to perform at a certain percentage energy efficiency at varying loads. One example is 80 Plus certified. For this certification, a power supply unit's efficiency is required to be 80% or greater at 10, 20, 50 and 100% of rated load, with a true power factor of 0.9 or greater. These percentage loads correspond roughly with light loads, typical, and peak load conditions.

Newer system modes however may only draw around 1-2% of the PSU load condition and accordingly, improvement is needed to improve the efficiency of a system operating at this ultra-low PSU load. While this ultra-low PSU load percentage may fluctuate depending on the power being drawn by the motherboard, the present techniques focuses on energy efficiency when operating at any low power level where the operation of powered components can be powered solely by the standby rail.

When a system is powered on, it may be operating at peak, typical, or light load by providing power to each of its components including hard disk drives, cooling fans, memory, graphics cards, peripherals, or any other attached components. Typically main voltage rails, or main rails, are optimized—to provide power when a system is operating at typical or near peak load conditions. However, the main rail is not optimized at extremely low loads.

The system may also operate in modes other than simply on and off. These modes can include, for example, a standby state, a hibernation state, and hybrids of each state. Typically in standby mode, the system state is held in RAM and, when placed in sleep mode, the computer cuts power to unneeded subsystems and places the RAM into a minimum power state, just sufficient to power the RAM and to be able to respond to a wake-up event. When a system is switched into standby mode, a lower voltage standby rail may be the only rail power being supplied to the system. Standby rails are often optimized for efficient use at lower system loads.

Sometimes, when a computer is still nominally on, it may only need to perform background tasks such as updating content for software applications it has installed or running at the time. This presents a situation where a system may still be powered on, however will operate inefficiently as the main power rail is typically not optimized for extremely low loads.

Embodiments described herein relate to dynamic PSU rail switching. In embodiments, the PSU can dynamically switch the system voltage supply from main rail to the standby rail, even though the system mode is not truly in standby mode as described above. The standby rail capacity may include the maximum ability for that rail to deliver power. This capacity for standby rails is often lower than that of the main rail, and accordingly is used for usually smaller power loads. In many PSUs, the standby rail is already optimized for extremely low load levels and accordingly, switching to the standby rail may be ideal for meeting certification requirements at extremely low load levels. As a result, the architecture and implementation of several new features in the desktop platform to support feature rich low power states can be used.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM), random access memory (RAM), magnetic disk storage media, optical storage media, flash memory devices, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a system 100 that may be used for dynamic PSU rail switching (DPRS), in accordance with an embodiment. The computing device 100 may be, for example, a laptop computer, desktop computer, ultrabook, tablet computer, mobile device, or server, among others. The computing device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the computing device 100 may include more than one CPU 102.

The computing device 100 may also include a graphics processing unit (GPU) 108. As shown, the CPU 102 may be coupled through the bus 106 to the GPU 108. The GPU 108 may be configured to perform any number of graphics operations within the computing device 100. For example, the GPU 108 may be configured to render or manipulate graphics images, graphics frames, videos, or the like, to be displayed to a user of the computing device 100. The GPU 108 includes a plurality of execution units 110. The executions units 110 may process threads from any number of graphics operations.

The memory device 104 can include random access memory (RAM), read only memory (ROM), flash memory, or any other suitable memory systems. For example, the memory device 104 may include dynamic random access memory (DRAM). The computing device 100 includes an image capture mechanism 112. In some embodiments, the image capture mechanism 112 is a camera, stereoscopic camera, scanner, infrared sensor, or the like.

The CPU 102 may be linked through the bus 106 to a display interface 114 configured to connect the computing device 100 to a display device 116. The display device 116 may include a display screen that is a built-in component of the computing device 100. The display device 116 may also include a computer monitor, television, or projector, among others, that is externally connected to the computing device 100.

The CPU 102 may also be connected through the bus 106 to an input/output (I/O) device interface 118 configured to connect the computing device 100 to one or more I/O devices 120. The I/O devices 120 may include, for example, a keyboard and a pointing device, wherein the pointing device may include a touchpad or a touchscreen, among others. The I/O devices 120 may be built-in components of the computing device 100, or may be devices that are externally connected to the computing device 100.

The computing device also includes a storage device 122. The storage device 122 is a physical memory such as a hard drive, an optical drive, a thumbdrive, an array of drives, or any combinations thereof. The storage device 122 may also include remote storage drives. The computing device 100 may also include a network interface controller (NIC) 124 may be configured to connect the computing device 100 through the bus 106 to a network 126. The network 126 may be a wide area network (WAN), local area network (LAN), or the Internet, among others.

The computing device 100 and each of its components may be powered by a power supply unit (PSU) 128. The CPU 102 may be coupled to the PSU through the bus 106 which may communicate control signals or status signals between then CPU 102 and the PSU 128. The PSU 128 is further coupled through a power source connector 130 to a power source 132. The power source 132 provides electrical current to the PSU 128 through the power source connector 130. A power source connector can include conducting wires, plates or any other means of transmitting power from a power source to the PSU.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

FIG. 2 is a flow diagram for a method 200 that performs dynamic PSU rail switching (DPRS). At block 202, a system, for example the computing system 100 seen FIG. 1, is supplied power from multi-rail PSU. Stated another way, when a system is working initially and the whole PSU is on, both the main rails and standby rail will be ON.

At block 204, power is removed from the main rail in response to an entry condition being met. Entry conditions for switching to standby rail may include an indication from a user, the system determining that all low power state checks are satisfied, a scheduled system signaling for a transition to this low power state, or any combination thereof. It should be noted that the entry condition to enter this low power state will differ from complete standby entry conditions, as the lower power state will allow various power limited features. By contrast, complete standby entry conditions do not allow power limited features. It should also be noted that a system determining that all low power state checks are satisfied can include a Basic Input Output System (BIOS) confirming all PSU powered devices are in a low power state, completely shut down. This state can often be called Runtime D3 (RTD3), where RTD3 can be either hot or cold. Entry conditions can also include any other checks that ensure that the power draw from the PSU can be below the maximum load conditions that can be supported on the standby rail alone.

At block 206, operations are performed using power from the standby rail. The operations that may be performed are not limited by the nature of the operation as the system is not in true “standby mode”. Instead, any system activity may continue to happen as long as this activity is constrained by the standby rail load capability. Staying under this standby rail capability may involve limiting the power consumption of the CPU and an input-output subsystem. This input-output subsystem may include and be referred to as a platform controller hub (PCH). For example, the CPU and PCH may be placed in a limited low frequency mode (Limited LFM) or thermal design power (TDP) as more fully discussed herein. In one embodiment, changing the mode of the CPU and the PCH may involve setting status bits of the CPU and PCH components to power limit the components when solely drawing power from the standby rail. These limits are based on the overall power budget possible for the particular standby rail in use by the system.

At block 208, power is returned to the main rail in response to an exit condition being met. These exit conditions can include a user request to exit the low power state, a scheduled system signaling for a transition to this low power state, the system detecting that load on the standby rail is or will exceed the capacity of the standby rails capacity, or any combination thereof. In some cases, the system may detect that the capacity of the standby rail is exceeded if the CPU or PCH reaches or exceeds the power or thermal limits as discussed above.

At block 210, power is supplied to the system, for example the computer system 100 seen in FIG. 1 from the multi-rail PSU. The PSU main rails can take some time to ramp back up to stable voltage levels. Accordingly, components requiring power from the main rail may wait until an indication is received from the PSU that the main rails are up and stable. In some cases, the PCH will receive an indication from the PSU that the main rails are ready for use, and then let other components of the system know power from the main rail is available. The other components can then take any required action. In some cases, an indication from the PSU that the main rails are available to supply power is the PSU_READY signal as seen in the timing diagram of FIG. 6. Once the PCH communicates that the main power rails are on, the CPU and PCH can clear the status bits to power limit themselves and transition themselves into an unconstrained power state, for example system power state S0.

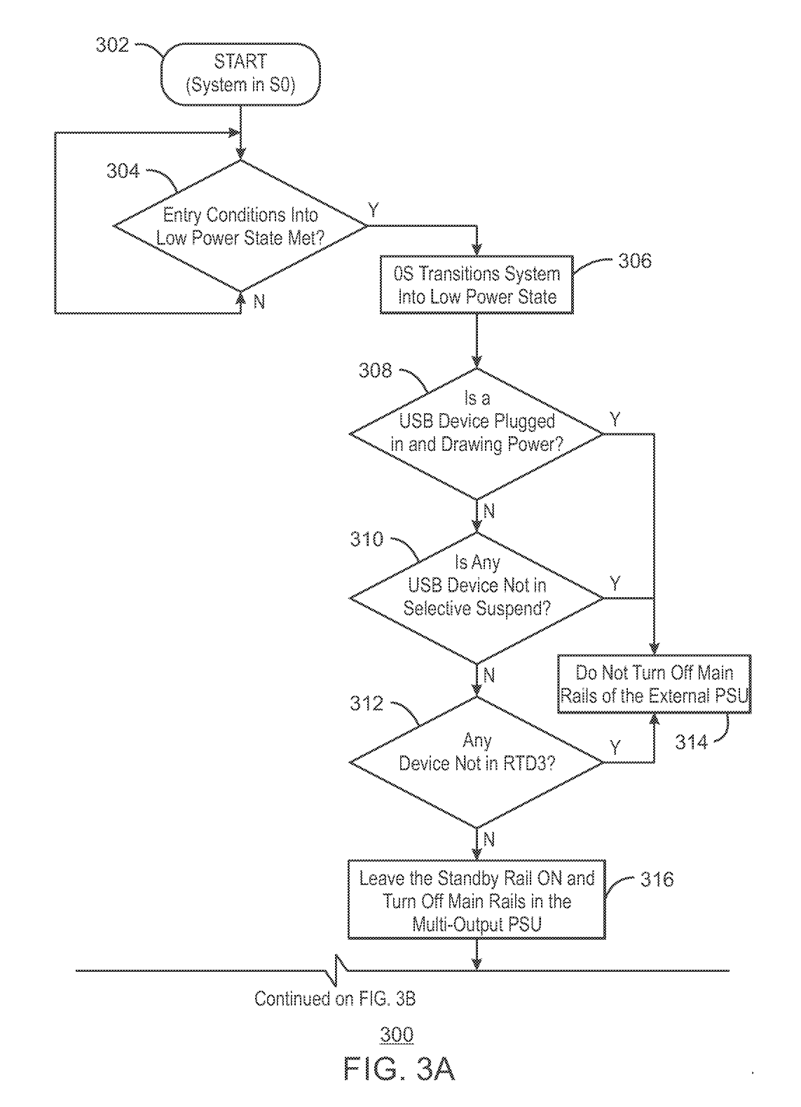

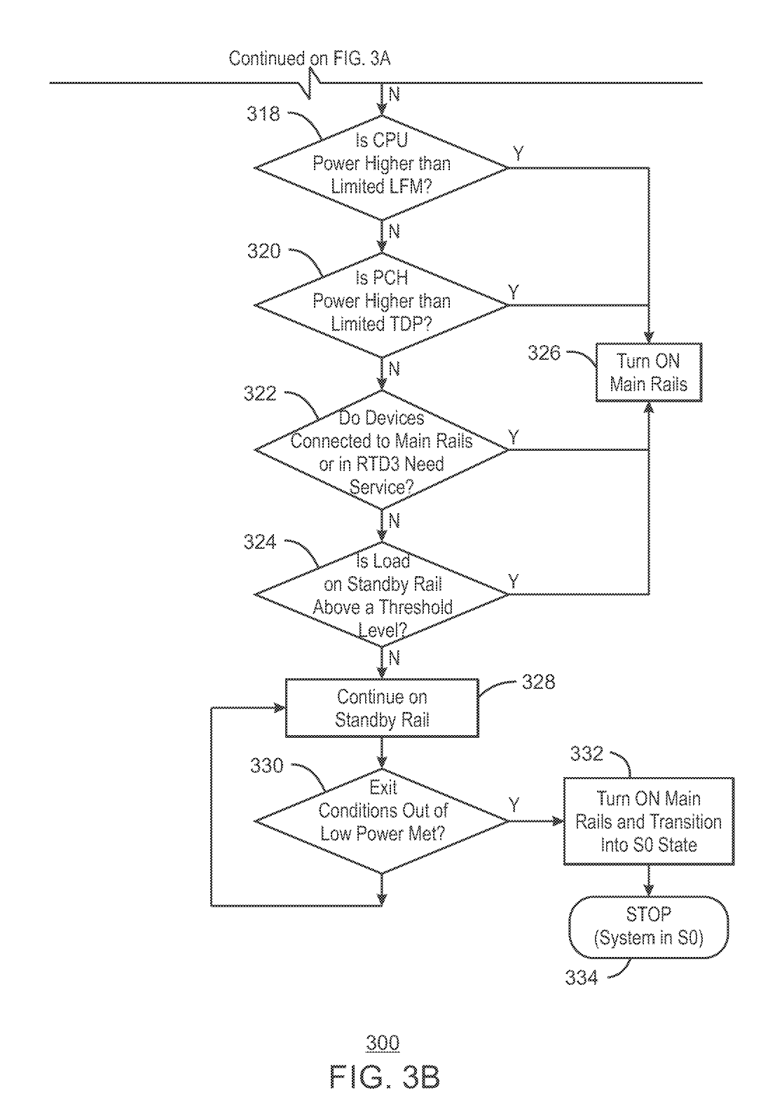

FIG. 3 is a flow diagram of a method 300 that performs DP RS. The process begins at block 302 where the system is in a system power state of S0. In power state S0, the system is completely operational, fully powered and completely retains a system context. As used herein, a system context may include volatile registers, memory caches, and RAM of the system. In some cases, S0 is also known as the ON state. While in S0, at block 304, it is determined if entry conditions into a low power state are met. If they have not, then the process does not proceed and instead continues to determine if entry conditions have been met. If yes, the entry conditions have been met, then the process proceeds to block 306 where the operating system (OS) transitions the system into a low power state. While in this low power state several determinations are made.

At block 308, it is determined if a USB device is plugged into the system 100 and drawing power. If yes, there is a USB device plugged into the system 100 and drawing power, then process flow continues to block 314.

While still in a lower power state, at block 310, it is determined if any USB device is not in a selective suspend state. Selective suspend is a state that includes a USB port that has signaled the OS that the port and device should be idled. This puts the individual USB port and device into a low power state. If it is determined that, yes, there is a USB device not in selective suspend, then the process flow continues to block 314.

While still in a lower power state, at block 312, it is determined if any device drawing power from the PSU is not in run time device power state 3 (RTD3). An RTD3 state includes devices that are in an OFF state and are in a low power state or are not drawing power at all. If it is determined that, yes, there is a device that is not in RTD3, then the process flow continues to block 314.

When the process is at block 314, the main rail of the external PSU is not turned off. Instead the process remains in a low power state. From block 314, the process may either restart, terminate, or resume immediately following block 306 and check to see if blocks 308, 310, and 312 can be answered ‘no’. When the answer to each of the determinations made at blocks 308, 310, and 312 is ‘no’, this indicates that the OS does not detect a USB device plugged in and drawing power, a USB device out of select suspend, or any device drawing power from the PSU that is out of RTD3. If this is the case, then the process flow continues to block 316.

At block 316, the standby rail is left on and the main rails in the multi-output or multi-rail PSU are turned off. This may be accomplished by the BIOS or PCH indicating to the PSU to turn off the main rails and just leave the standby rail powered on. Once the standby rail is left on and the main rails have been turned off, several determinations are made.

At block 318, it is determined if the CPU power is higher than limited low frequency mode (LFM). The LFM of the CPU includes the power limit setting for the operation of the CPU such that the system may maintain its low power level setting. If it is determined that yes, the CPU power is higher than Limited LFM, then the process flow continues to block 326.

At block 320, it is determined if a platform controller hub (PCH) is using more power than permitted by a Limited thermal design power (TDP). A TDP refers to a set power limit for the PCH such that the system may maintain its low power level setting. If it is determined that yes, the PCH power is higher than a Limited TDP, then the process flow continues to block 326.

At block 322, it is determined if the devices connected to the main rails or in RTD3 need service. A device needs service if it is needed for some kind of input/output operation. Further a device needed for service is a device needed for exit from RTD3 or for device wake functions. If it is determined that yes, the devices connected to the main rails or in RTD3 need service, then the process flow continues to block 326.

At block 324, it is determined if the load on the standby rail is above a threshold level. This threshold level may be a predetermined load value stored in additional circuitry on the motherboard or in memory that was selected by a user or predetermined by software. If it is determined that yes, the load on the standby rail is higher than a threshold level, then the process flow continues to block 326.

At block 326, the main rails are powered on. It should further be noted that blocks 320, 322, 324 need not proceed in sequence. The conditions of blocks 320, 322, and 324 could trip at any time and in any order and each would lead to the turning on of the power rails at block 326. Block 326 is one point where the process flow may terminate and other operations or code may begin. Alternatively, the process could restart at block 302 or other block where the main rail is powered on including blocks 304-312. However, if none each of the determinations of blocks 318-324 is answered no, this indicates that the CPU power is not higher than a Limited LFM, PCH power is not higher than a Limited TDP, devices connected to the main rails or in RTD3 do not need service, and the load on standby is not above a threshold level. If this is the case, then the process flow proceeds to block 328.

At block 328, the process maintains a system in a state where it is only powered by the standby rail. In this state, the system should continue to recheck the above mentioned determinations to ensure the platform power consumption remains within the STBY rail load capacity limits. If any of these conditions are met, they may count as an exit condition from the low power state. If no, the exit conditions out of low power state have not been met, then the process returns to block 328 and maintains a system in a state where it is only powered by the standby rail. If however, yes, the exit conditions out of low power state have been met, then the process proceeds to block 332 where the main rails are turned on and the system transitions into an S0 state. This may be accomplished by the BIOS or PCH indicates to the PSU to turn back ON the main rails where the system may then transition into the S0 state.

At block 334, the process then concludes and the system may then execute other instructions. Alternatively the process may also repeat the process by starting again at block 302.

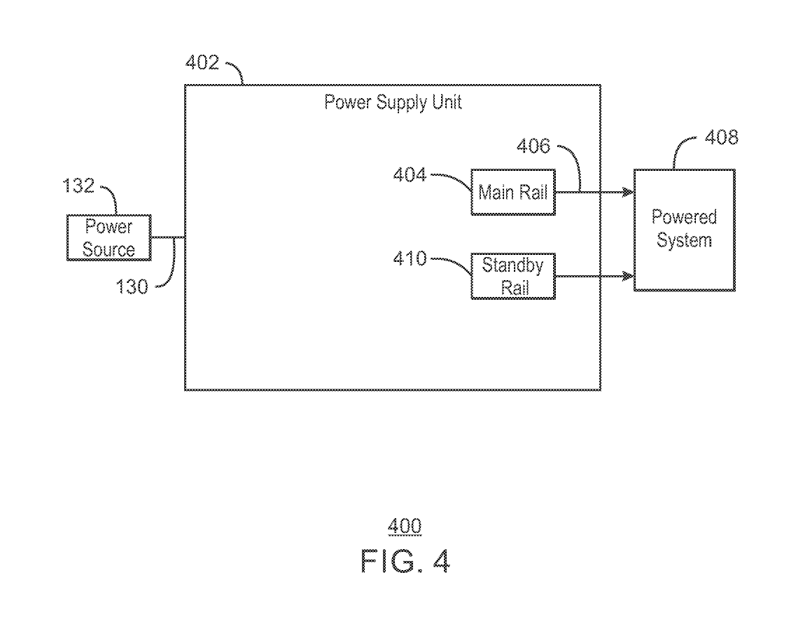

FIG. 4 is a block diagram of a system 400. A PSU 402 draws power through a power source connection 130 from a power source 132. The PSU 402 contains multiple rails including a main rail 404 that provides power over a PSU connector 406 to a powered system 408. Reference to a main rail 404 also includes multiple main rails for example 5V, 12V, and 3.3V in a multi-rail ATX PSU. A powered system 408 can include the system disclosed in FIG. 1. A powered system may also include any system or combination of components that is drawing power from the PSU. The PSU 402 also contains a standby rail 410 that provides power over a PSU connector to the powered system 408. The standby rail 502 may be monitored by an overcurrent mechanism. The overcurrent mechanism may monitor the standby rail and trip in response to an excess current being detected by the overcurrent mechanism. Rather than simply monitoring for an excess of current as though the system were in standby mode, the overcurrent may be separately set to trip at other current levels that reflect other limits on operation during this low power state. The tripping of this mechanism could signal that a main rail needs to be turned on to provide more adequate power to a system. The actual limits on what will trip the overcurrent mechanism can be set based on the available overall capacity of the standby rail to provide power. Detection of excess current on the standby rail may serve as a catch all way of ensuring that when any component is reaching or exceeding its power, thermal, or device usage limit, the system will exit this low power condition and turn on the main rails. Accordingly, the tripping of this rail could serve as an exit condition for the methods, systems, and embodiments herein disclosed.

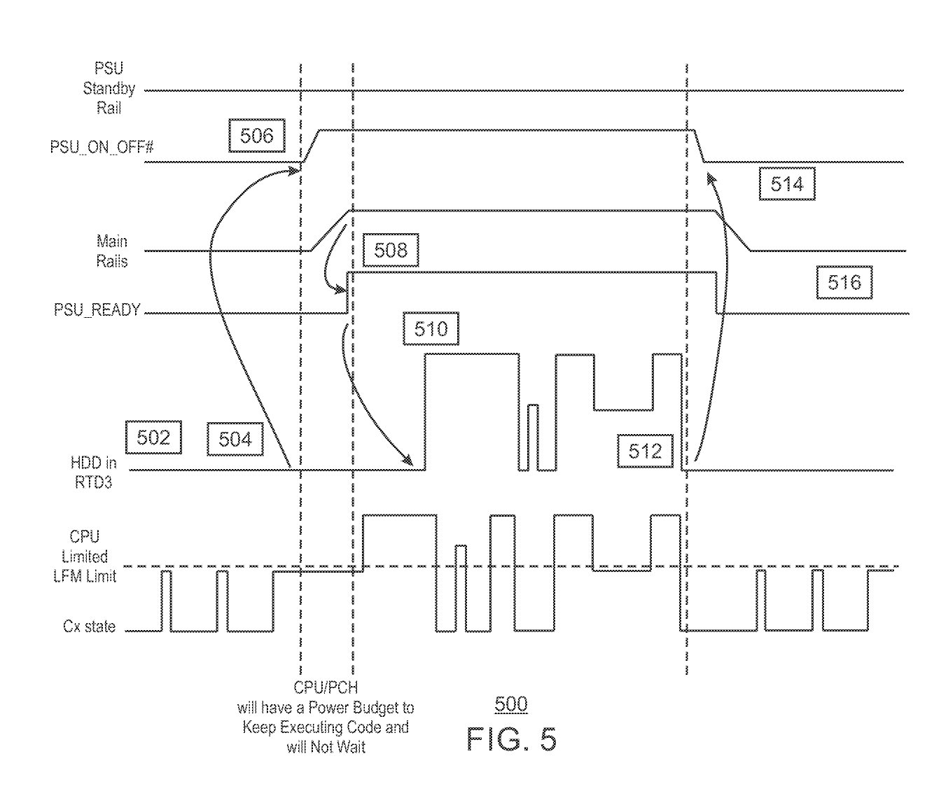

FIG. 5 is a timing diagram 500 illustrating a possible timing for the switching of rails, as well as the power states of the system and the signals provided to the system and PSU. Each of the horizontal signal lines are labeled to illustrate a rail, signal, or state, respectively. For example, the Cx state signal line indicates, in part, the processing state of the system at various levels. Cx state should be understood as the CPU C-state power states. These are power states of the CPU with notation C0-C7 (for desktop) or lower for mobile microarchitecture platforms. When the system is not actively working and is in idle conditions the CPU tends to go into the lowest C-state available. As this exact lowest state may vary by platform, it is indicated here as Cx state rather than specifically indicating C7 or C6 state. Further, it should be understood that this diagram is merely illustrative, and that the invention is not to be limited by the process, method, or sequence here described.

Initially in FIG. 5, all active components in the platform are drawing power only from the standby rail. When the HDD needs to be accessed there is a high possibility that this new load cannot be supported on the standby rail. Hence the platform ingredients should work together to turn on the main rails. As these transitions in the timing diagram take place as seen in blocks 502-516, the system switches from using the standby rail only to the main rails and back.

At the block 502, the OS device driver requests device access. As seen in FIG. 6, this request corresponds to a small spike in the Cx state signal line.

At block 504, BIOS requests access and an RTD3 power state exit. This signal for RTD3 exit also results in an indication to the PCH to turn on the main rail. Again, a small spike in the Cx state signal line is seen to correspond at the same time as block 504.

At block 506, the PCH turns on the PSU by asserting PSU_ON_OFF# signal. As the PSU_ON_OFF# signal edge goes high the Main rails begin to turn on, however some time will pass until the main rails are providing the full power needed by the system. During this time, and prior to block 508, the main rail is still in the process of turning on, the CPU and PCH will still have a power budget to continue operation within the power limits provided by the standby rail as it continues to provide power. Accordingly, unlike other components still in RTD3, these components will not wait to operate as the main rail is turning on.

At block 508, the main rail has finished powering on, the PSU asserts PSU_READY signal. After PSU_READY signal and prior to block 510, time may be required for the device to exit RTD3.

At block 510, and upon PSU_READY, the PCH indicates to BIOS that the main rails are powered, and in response, BIOS will finish bringing the device out of RTD3. After the device is out of RTD3, diagram 500 shows example operations with both the main rails and the standby rail powered on.

At block 512, in response to either a user request, or due to a period of inactivity, the device enters RTD3, at which point BIOS indicates to the PCH that it may turn off the main rails. As indicated above in other embodiments, other checks may be necessary before the main rail may be powered down.

However, if these checks are successfully made, at block 514, PCH de-asserts PS_ON_OFF# and the signal edge transitions to a low state.

At block 516, the PSU main rails are turned OFF and the system proceeds in a low power state running on the standby rail alone. When powered by only the standby power rail, the system may perform low power features as disclosed elsewhere in this application.

The presently disclosed system, process, and embodiments disclose powering a system off a standby rail alone. This allows systems which still are operating, only at low power levels, increase their efficiency as the standby rail in multi-rail PSUs is already optimized for low load conditions. Switching to this rail in the appropriate low platform power conditions in desktop systems, server systems, mobile systems, or any system with multi-rail or multi-output power supplies, will allow the system to take advantage of its high efficiency and reduce the power losses attributed to the power delivery system. As power losses attributed to the PSU are reduced, the overall power consumption by the platform will also be reduced.

The presently disclosed system, process, and embodiments disclose that the system powered from the standby rail under will maintain an active condition of a low power state. This active condition may only allow certain OS background housekeeping or networking activities to occur, until exit or switching conditions are met. These conditions are described herein and also include when a component such as a desktop hard drive needs to be powered. These conditions further include any time wherein the load on the standby rail may become too high and the system needs to switch to the main rails so that power requirements can be met.

This way of switching between the main rails and the standby rail as the system power demands change, rather than switching from sleep state, is herein disclosed. This disclosure also pertains to a control mechanism for this dynamic PSU rail switching (DPRS). Included in the disclosure of the control mechanism are the conditions under which the switching takes place. An implementation of these ideas and changes may result in changes to power delivery and sequencing architecture.

In addition to allowing the production of more energy efficient systems, the present invention provides a way of accomplishing this energy efficiency with minimal changes to the computing ecosystem and infrastructure. The present invention—will assist in meeting the relatively stringent energy regulations such as—Energy Star and ErP Lot3 (market access). Moreover, the present invention allows these standards to be met while also improving user experience by allowing low energy features to continue operation while in the low power state. In addition to the implementations herein described, this low power state may also provide signals to implement low power system states such as Microsoft's “connected standby” system state.

### Example 1

One embodiment includes a method of managing low power delivery in systems for dynamic power supply rail switching. This method of managing power delivery may be accomplished, in part, via supplying power from a standby rail and removing power from a main rail in response to an entry condition being met. This method of managing power delivery may also include performing operations using power from the standby rail. This method of managing power delivery may also then include returning power to the main rail in response to an exit condition being met and supplying power from the main rail. The entry condition may also include a determination that the execution of instructions requires less power than can be supplied by the standby rail. The entry condition may also include a determination that a device is in at least one of a low power state or an unpowered state. The entry condition may also include a user entry request. The entry condition may also include maintaining the processor in a limited low frequency mode, maintaining an input/output (I/O) subsystem below a limited thermal design power, or any combination thereof. The exit condition may also include a determination that the processor has exceeded a power limit associated with a limited low frequency mode. The exit condition may also include a determination that an I/O subsystem has exceeded a power limit associated with a limited thermal design power. The exit condition may also include a user exit request. The exit condition may also include a determination that a device access is required. This method of managing power delivery may also include tripping an overcurrent mechanism in response to an excess of current while the overcurrent mechanism monitors the standby rail. The exit condition may also include the overcurrent mechanism tripping.

### Example 2

Another embodiment includes an apparatus for dynamic power supply rail switching including a multi-rail power supply. This multi-rail power supply includes a main rail and a standby rail. In this apparatus, the multi-rail power supply may supply power to a system from the standby rail, and in response to an entry condition being met, remove power from the main rail. The multi-rail power supply may also return power to the main rail in response to an exit condition being met and supply power to the system from the main rail. The entry condition may also include a determination that an execution of instructions requires less power than the capacity of the standby rail. The entry condition may also include maintaining an input/output (I/O) subsystem below a limited thermal design power. The entry condition may also include a determination that a device is in at least one of a low power state or an unpowered state. The entry condition may also include maintaining a processor in a limited low frequency mode. The entry condition may also include a user entry request. The exit condition may include a user exit request or a determination that a processor has exceeded a power limit associated with a limited low frequency mode. The exit condition may also include a determination that an input/output (I/O) subsystem has exceeded a power limit associated with a limited thermal design power. The exit condition may also include a determination that a device access is required. The multi-rail power supply may also include an overcurrent mechanism that monitors the standby rail and trips in response to an excess of current being detected by the overcurrent mechanism. The exit condition may also include an overcurrent mechanism tripping.

### Example 3

Another embodiment includes a system for dynamic power supply rail switching further including a multi-rail power supply. This multi-rail power supply further includes a main rail and a standby rail. The system further includes a memory that is to store instructions and that is communicatively coupled to the multi-rail power supply and a processor communicatively coupled to the memory and the multi-rail power supply, wherein when the processor is to execute instructions. The multi-rail power supply is to also supply power to the system from the standby rail, and in response to an entry condition being met, remove power from the main rail. The multi-rail power supply is to also return power to the main rail in response to an exit condition being met and supply power to the system from the main rail. The entry condition may further include a determination that the execution of instructions requires less power than the capacity of the standby rail. The entry condition may further include maintaining an input/output (I/O) subsystem below a limited thermal design power. The entry condition may further include a determination that a device is in at least one of a low power state or an unpowered state. The entry condition may further include maintaining the processor in a limited low frequency mode. The entry condition may further include a user entry request. The exit condition may further include a user exit request or a determination that the processor has exceeded a power limit associated with a limited low frequency mode. The exit condition may also include a determination that either the processor or an input/output (I/O) subsystem has exceeded a power limit associated with a limited thermal design power. The exit condition may also include a determination that a device access is required. This multi-rail power supply further includes an overcurrent mechanism that monitors the standby rail and trips in response to an excess of current being detected by the overcurrent mechanism. The exit condition further includes an overcurrent mechanism tripping.

### Example 4

Another embodiment includes a tangible, machine-readable storage medium comprising code that, when executed on a machine for dynamic power supply rail switching cause a processor to supply power to the system from a standby rail and remove power from a main rail in response to an entry condition being met. This embodiment further returns power to the main rail in response to an exit condition being met and supply power to the system from the main rail. The tangible, machine-readable storage medium further includes an overcurrent mechanism that monitors the standby rail and trips in response to an excess of current being detected by the overcurrent mechanism. The exit condition includes the overcurrent mechanism tripping. The entry condition includes a determination that the execution of instructions requires less power than the capacity of the standby rail. The entry condition further includes maintaining an input/output (I/O) subsystem below a limited thermal design power. The entry condition further includes a determination that a device is in at least one of a low power state or an unpowered state. The entry condition further includes maintaining the processor in a limited low frequency mode. The entry condition further includes a user entry request. The exit condition includes a user exit request. The exit condition further includes a determination that the processor has exceeded a power limit associated with a limited low frequency mode. The exit condition further includes a determination that an input/output (I/O) subsystem has exceeded a power limit associated with a limited thermal design power. The exit condition further includes a determination that a device access is required.

### Example 5

Another embodiment includes an apparatus for dynamic power supply rail switching including means to supply power from multiple rails. These means for supplying power from multiple rails includes a main rail and a standby rail. In this apparatus, the means for supplying power from multiple rails includes supplying power to a system from the standby rail, and in response to an entry condition being met, remove power from the main rail. The means for supplying power from multiple rails may also return power to the main rail in response to an exit condition being met and supply power to the system from the main rail. The entry condition may also include a determination that an execution of instructions requires less power than the capacity of the standby rail. The entry condition may also include maintaining an input/output (I/O) subsystem below a limited thermal design power. The entry condition may also include a determination that a device is in at least one of a low power state or an unpowered state. The entry condition may also include maintaining a processor in a limited low frequency mode. The entry condition may also include a user entry request. The exit condition may include a user exit request or a determination that a processor has exceeded a power limit associated with a limited low frequency mode. The exit condition may also include a determination that an input/output (I/O) subsystem has exceeded a power limit associated with a limited thermal design power. The exit condition may also include a determination that a device access is required. The means for supplying power from multiple rails may also include means to monitor the standby rail where the means to monitor the standby rail trips in response to an excess of current being detected by the means to monitor the standby rail. The exit condition may also include the means to monitor the standby rail tripping.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result. Further, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A system for dynamic power supply rail switching, comprising:
a multi-rail power supply, wherein the multi-rail power supply includes:
a main rail; and
a standby rail;
a memory that is to store instructions and that is communicatively coupled to the multi-rail power supply; and
a processor communicatively coupled to the memory and the multi-rail power supply, wherein when the processor is to execute instructions, the multi-rail power supply is to:
supply power to the system from the standby rail, and in response to an entry condition being met, remove power from the main rail; and
return power to the main rail in response to an exit condition being met and supply power to the system from the main rail.

2. The system of claim 1, wherein the entry condition includes a determination that the execution of instructions requires less power than the capacity of the standby rail.

3. The system of claim 2, wherein the entry condition includes maintaining the input/output (I/O) subsystem below a limited thermal design power.

4. The system of claim 1, wherein the entry condition includes a determination that a device is in at least one of a low power state or an unpowered state.

5. The system of claim 1, wherein the entry condition includes maintaining the processor in a limited low frequency mode.

6. The system of claim 1, wherein the entry condition includes a user entry request.

7. The system of claim 1, wherein an exit condition includes a user exit request.

8. The system of claim 1, wherein the exit condition includes a determination that the processor has exceeded a power limit associated with a limited low frequency mode.

9. The system of claim 1, wherein the exit condition includes a determination that an input/output (I/O) subsystem has exceeded a power limit associated with a limited thermal design power.

10. The system of claim 1, wherein the exit condition includes a determination that a device access is required.

11. The system of claim 1, comprising an overcurrent mechanism that monitors the standby rail and trips in response to an excess of current being detected by the overcurrent mechanism.

12. The system of claim 1, wherein the exit condition includes an overcurrent mechanism tripping.

13. A method of managing low power delivery in systems for dynamic power supply rail switching via:
supplying power from a standby rail and removing power from a main rail, in response to an entry condition being met;
performing operations using power from the standby rail;
returning power to the main rail in response to an exit condition being met; and
supplying power from the main rail.

14. The method of claim 13, wherein the entry condition includes: a determination that a device is in at least one of a low power state or an unpowered state, a determination that the execution of instructions requires less power than can be supplied by the standby rail, or any combination thereof.

15. The method of claim 13, wherein the entry condition includes maintaining the processor in a limited low frequency mode, maintaining an input/output (I/O) subsystem below a limited thermal design power, or any combination thereof.

16. The method of claim 13, wherein the exit condition includes:
a determination that the processor has exceeded a power limit associated with a limited low frequency mode;
a determination that an I/O subsystem has exceeded a power limit associated with a limited thermal design power;
a determination that a device access is required; or
any combination thereof.

17. The method of claim 13, comprising:
tripping an overcurrent mechanism in response to an excess of current while the overcurrent mechanism monitors the standby rail.

18. The method of claim 13, wherein the exit condition includes the overcurrent mechanism tripping.

19. A non-transitory machine accessible storage medium having instructions stored thereon that when executed on a machine for dynamic power supply rail switching cause the machie to:
supply power to the system from a standby rail and remove power from a main rail in response to an entry condition being met;
return power to the main rail in response to an exit condition being met and supply power to the system from the main rail.

20. The non-transitory machine accessible storage medium of claim 19, including an overcurrent mechanism that monitors the standby rail and trips in response to an excess of current being detected by the overcurrent mechanism.

21. The non-transitory machine accessible storage medium of claim 20, wherein the exit condition includes the overcurrent mechanism tripping.
